(19) United States
(12) Patent Application Publication
(10) Pub. No.: US 2006/0242631 A1
(43) Pub. Date: Oct. 26, 2006

(54) Process and system for sharing program fragments

(76) Inventors: Jakob Roland Andersen, Hoejbjerg (DK); Lars Bak, Tranbjerg J (DK); Kasper Verdich Lund, Hoejbjerg (DK); Steffen Grarup, Hoejbjerg (DK)

Correspondence Address: PERKINS COIE LLP, P.O. BOX 2168, MENLO PARK, CA, 94026, US

(21) Appl. No.: 11/112,727

(22) Filed: Apr. 22, 2005

(51) Int. Cl. G06F 9/45

(52) U.S. Cl. 717/137

(57) ABSTRACT

A technique for sharing code fragments involves detecting identical code fragments, then replacing code fragments with references to an identical code fragment. A process according to the technique may include detecting identical code fragments in one or more modules, presenting at runtime a single code fragment that is identical to the identical code fragments, and automatically sharing the single code fragment among the one or more modules. A system according to the technique may include a code fragments database that may includes code fragments and a code server configured to receive requests for a program and provide references to one or more of the code fragments in the code fragments database. Another system according to the technique may include a first object, a second object, and a method object, wherein a reference associated with a first method of the first object and the reference associated with a second method of the second object are pointers to the method object.

### BACKGROUND

The present invention relates to computer memory management. More particularly, the present invention relates to linking software components.

Embedded devices are often memory-constrained. Adding functionality to an embedded device means using memory to store the code necessary for the functionality. Thus, embedded device vendors have to balance functionality versus memory usage, and often have to leave out functionality to be able to fit the program in available memory.

Embedded devices may also be able to dynamically obtain new functionality in the form of program code over a network connection. Sending such code over the network connection requires network bandwidth in proportion with the amount of code that must be transferred to obtain the new functionality.

Program code may be referred to as comprising many “code fragments,” often structured as methods that can be invoked. Some programming languages, such as, for example, Java™, support method-sized code fragments. Other programming languages, such as Smalltalk, support smaller code fragments called “blocks,” where each method may contain several blocks. This functionality is described in Smalltalk-80: The Language and Its Implementation by Adele Goldberg and David Robson (Addison-Wesley, 1984), which is incorporated herein by reference.

FIG. 1 depicts a conceptual view 100 of compiling source code and representing the source code as runnable code. As shown in the conceptual view 100, source code 102 and 104 is compiled into respective objects 112 and 114. The objects 112 and 114 include respective virtual machine instructions 122 and 124. In the example of FIG. 1, the VM instructions 122 and 124 are identical, though the source code 102 and 104 is not. It may be noted that the smaller a code fragment, the larger the possibility that another code fragment identical to the first code fragment is already present on the device.

It may be beneficial to reuse identical code fragments, such that only one copy of the code exists on the device. Moreover, it may be beneficial to know in advance what code fragments exist on a device, so that such code fragments need not be transmitted when uploading new functionality to the device.

Known techniques allow limited sharing of similar code between programs. For example, some development tools enable developers to place methods in shared libraries. A dynamic linker ensures that only one copy of the shared library exists, and that the copy is shared by the programs that use the methods in the library. Shared libraries are common in modern operating systems, such as Microsoft® Windows™ where they are known as Dynamic Link Libraries, as described in Programming Windows® (5ₜₕ Edition) by Charles Petzold (Microsoft Press, 1998), which is incorporated herein by reference.

Developers of shared libraries typically must anticipate what code fragments others might be interested in reusing. Moreover, shared libraries typically require that other developers know that the shared library contains the code fragments they need. In other words, both parties must explicitly state their intent to share code fragments.

Another technique for sharing code fragments is the use of object-oriented programming. Object-oriented programming supports sharing through inheritance, as described in On the Notion of Inheritance by Antero Taivalsaari (ACM Computing Surveys, Vol. 28, No. 3, 1996), which is incorporated herein by reference. Using inheritance, a developer can create a subclass of an already existing class and thereby inherit (share) its methods. Inheritance allows developers to structure their programs for sharing, since shared behavior and inheritance relationships are an integral part of the object-oriented program design process.

Sharing through inheritance is used in object-oriented platforms such as Java™. A Java™ virtual machine (VM) is responsible for running the code that ensures that for each shared method, only one copy of the method exists, as described in The Java™ Virtual Machine Specification (2^{nd} Edition) by Tim Lindholm and Frank Yellin (Addison-Wesley, 1999), which is incorporated herein by reference.

These sharing techniques require that developers design programs with sharing in mind. Either the code must be put in a separate shared library or in a superclass of the classes that use the shared code. These sharing techniques do not address the issue of two otherwise unrelated code fragments being identical. For example, two different methods may, when translated from source code into runnable code, end up being identical (i.e., containing semantically equivalent code, such as the same instructions). This is especially likely for small methods, even if the methods are written in different programming languages. However, the developers might not be aware that the methods are, in fact, identical. Since prior art techniques require that developers be aware of and explicitly state an intention to share, two methods having the same functionality could exist in memory at runtime.

### SUMMARY

A technique for sharing code fragments involves detecting identical code fragments, then replacing code fragments with references to an identical code fragment. In an embodiment, a process according to the technique may include detecting identical code fragments in one or more modules, presenting at runtime a single code fragment that is identical to the identical code fragments, and automatically sharing the single code fragment among the one or more modules.

In another embodiment, the modules may include objects. In another embodiment, detecting the identical code fragments may include analyzing runnable code. In another embodiment, automatically sharing the single code fragment may include sharing a complete method. In another embodiment, automatically sharing the single code fragment may include sharing a block. In another embodiment, automatically sharing the single code fragment may involve referencing the single code fragment using pointers.

In another embodiment, the single code fragment may include a method object, and automatically sharing the single code fragment may include pointing objects associated with each of the identical code fragments to the method object. In another embodiment, detecting identical code fragments, presenting the single code fragment at runtime, and automatically sharing the single code fragment occur sequentially without user involvement.

In another embodiment, the process also may include receiving new code from a server, determining whether the single code fragment is identical to a code fragment in the new code, replacing the code fragment in the new code with a reference to the single code fragment if it is determined that the single code fragment is identical to the code fragment in the new code, and saving the code fragment in the new code for comparison against code fragments from future new codes if it is determined that the single code fragment is not identical to the code fragment in the new code.

In another embodiment, the process also may include maintaining a list of first code fragments, including the single code fragment, in a code fragment database, introducing a set of second code fragments, each of which are identical to a code fragment in the code fragment database, and a set of third code fragments, none of which are identical to a code fragment in the code fragment database. The introducing may be by substituting a reference to one of the first code fragments for each of the set of second code fragments and adding each of the set of third code fragments to the code fragment database. In another embodiment, the process also may include dynamically uploading code at runtime.

In another embodiment, the process may include writing source code of a program in a programming language, translating the source code into runnable code, and providing the runnable code as at least one module of the one or more modules. In this embodiment executing the runnable code may include executing the runnable code using a virtual machine.

In an embodiment, a system made according to the technique may include a code fragments database that may include a plurality of code fragments and a code server configured to receive requests for a program and provide references to one or more of the plurality of code fragments in the code fragments database, wherein the one or more of the plurality of code fragments may be associated with the requested program.

In an embodiment, the code server may further be configured to detect identical code fragments in one or more objects. In another embodiment, the code server may further be configured to download the program and update the code fragments database in accordance with code fragments in the program. In another embodiment, the code server may further be configured to build and maintain the code fragments database.

In another embodiment, the system may include a developer I/O module configured to provide new code fragments to the code server, wherein the code server is further configured to update the code fragment database according to the new code fragments.

Another system made according to the technique may include a first object, including a reference associated with a first named method, a second object, including a reference associated with a second named method, and a method object, wherein the reference associated with the first named method and the reference associated with the second named method are pointers to the method object. In an embodiment, the first object and the second object may be associated with different classes.

### BRIEF DESCRIPTION OF THE DRAWINGS

Embodiments of the invention are illustrated in the figures. However, the embodiments and figures are illustrative rather than limiting; they provide examples of the invention.

FIG. 1 (prior art) depicts a conceptual view of compiling source code and representing the source code as runnable code.

FIG. 2 depicts a conceptual view of compiling source code and representing the source code as runnable code according to an embodiment.

FIG. 3 depicts a system for provisioning a client with programs according to an embodiment.

FIG. 4 depicts a system for provisioning a client with programs according to another embodiment.

FIG. 5 depicts a system for provisioning a client with programs according to another embodiment.

FIGS. 6A, 6B, and 6C depict systems that include a client system with a developer environment according to an embodiment.

FIG. 7 depicts a networked system for use in an embodiment.

FIG. 8 depicts a computer system for use in the system of FIG. 7.

FIGS. 9A, 9B, 9C, and 9D depict flowcharts according to embodiments.

### DETAILED DESCRIPTION

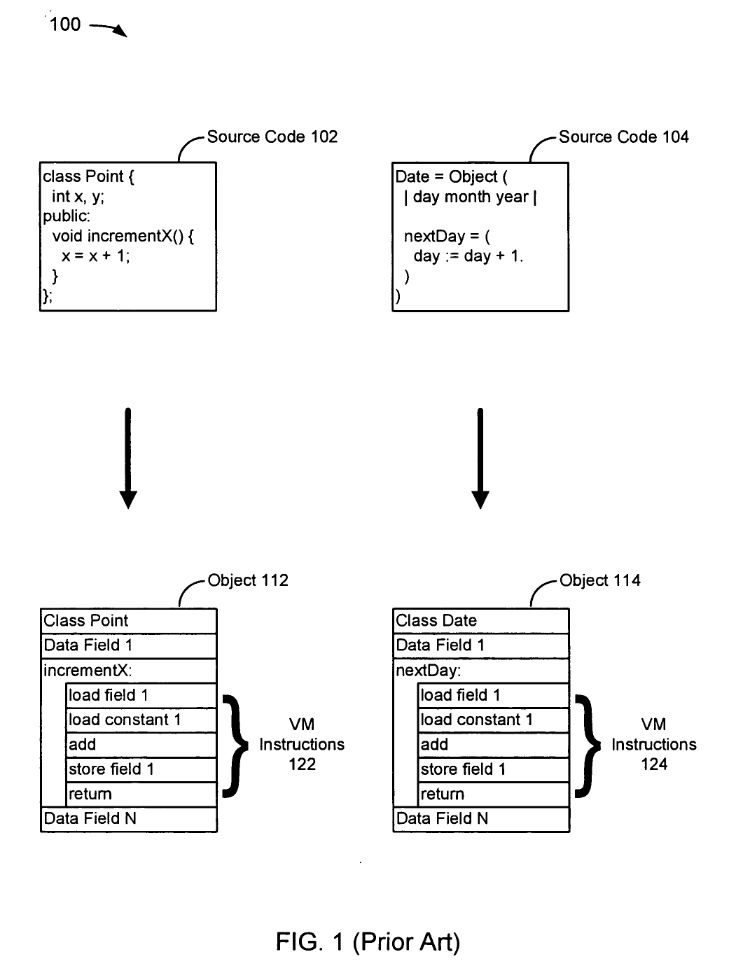

FIG. 1 (prior art) is described above in the background section of the specification.

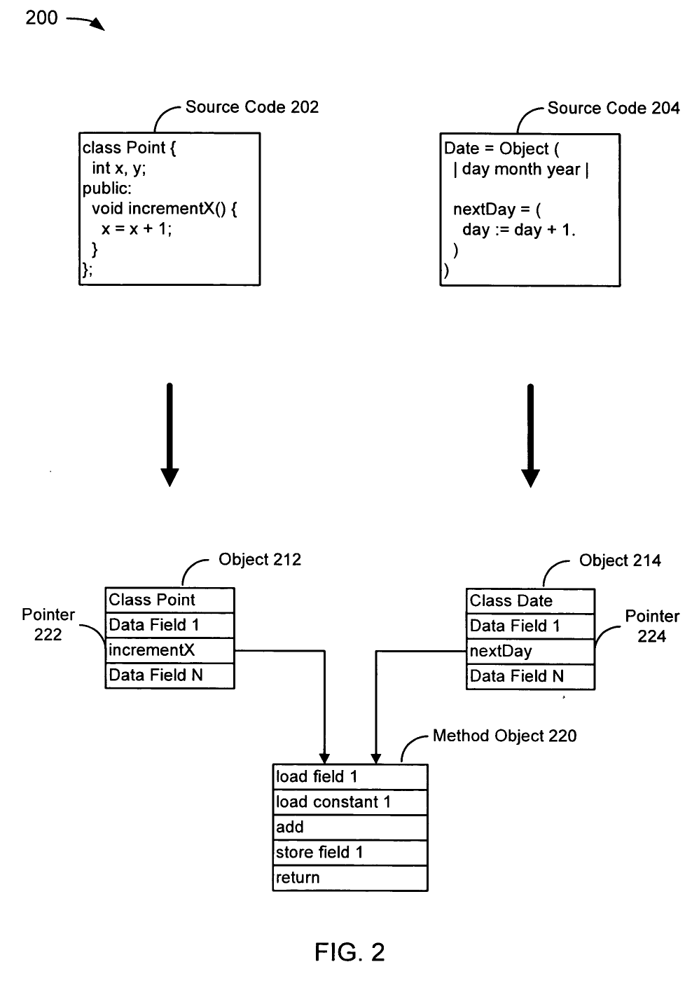

FIG. 2 depicts a conceptual view 200 of compiling source code and representing the source code as runnable code according to an embodiment. The conceptual view 200 includes source code 202, source code 204, an object 212, and object 214, a method object 220, a pointer 222, and a pointer 224.

In the example of FIG. 2, the source code 202 and the source code 204 is written in C++. However, any programming language, including Java™, could be used. Indeed, the source code 202 and the source code 204 may be written in different languages. Advantageously, in an embodiment, code fragments are analyzed post-compilation as runnable code, which typically makes the specific language in which the code is written irrelevant. Moreover, even in a single programming language, there may be multiple ways to express the same instructions. For example, two source code fragments with different source code text may be semantically equivalent and, accordingly, compile into identical runnable code fragments.

The source code 202 is translated into the object 212 and the source code 204 is translated into the object 214. The translation may be by way of, for example, a compiler. As is known in the art of computer programming, a compiler may create runnable code that is executable by a computer. For example, the runnable code may be executable by computer hardware associated with the computer. Alternatively, the runnable code may be executed by an interpreter, such as is included in, for example, a Java™ Virtual Machine (VM).

In the example of FIG. 2, the object 212 is represented as a set of data fields, one of which includes the pointer 222. Similarly, the object 214 is represented as a set of data fields, one of which includes the pointer 224. Additional pointers (not shown) may be included in data fields, as well. In an alternative, the system need not be implemented in an object-oriented fashion. In this alternative, the object 212 and the object 214 may simply be implemented as a non-object data structure with data fields.

In the example of FIG. 2, the method object 220 is represented as a virtual machine (VM) instruction set. As is known in the art of computer programming, there are multiple possible representations of the instruction set, including machine language or assembly language. For illustrative purposes, FIG. 2 depicts a VM instruction set.

In VM systems, the code for methods is often stored in method objects, such as the method object 220. Typically, method objects include, in addition to the code, information such as the name of the method and the class in which the method is defined. Since, in an embodiment, method objects are shared regardless of, for example, the method name, the name is not always necessary. Indeed, the method object 220, in an embodiment, includes only runnable code.

Since, in the example of FIG. 2, a code fragment associated with the source code 202 and 204 is semantically equivalent and the VM instruction set is, accordingly, identical, the pointers 222 and 224 may be used to point to the same instruction set. In the example of FIG. 2, the semantically equivalent portion of the source code 202 and the source code 204 is the portion of the code that adds one to the first field of the object invoked on. In other words, “x=x+1” and “day:=day +1” are semantically equivalent. Both of these instructions may be associated with the instruction set depicted in the method object 220, which encapsulates the instruction set.

Notably, the source code 202 and the source code 204 do not include code that is specifically directed to sharing the method object 220. Advantageously, in an embodiment, static specification of which code fragments to share is not required.

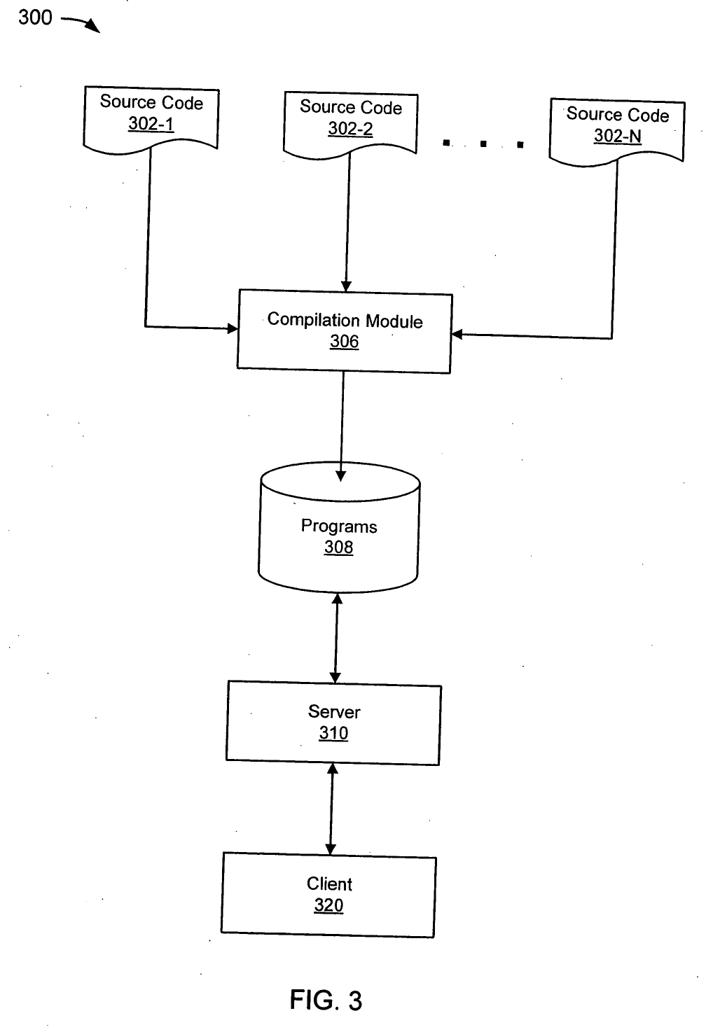

FIG. 3 depicts a system 300 for provisioning a client with programs according to an embodiment. The system 300 includes source code programs 302-1 to 302-N (referred to collectively hereinafter as the source code programs 302), a compilation module 306, a programs database 308, a server 310, and a client 320.

In the example of FIG. 3, the source code programs 302 may be written in one or more programming languages. The compilation module 306 may convert the source code programs 302 into runnable code. The source code programs 302 may be created at any time and in any location prior to compilation by the compilation module 306. Thus, for example, editor software may be implemented on a first computer, facilitating development of source code by a developer. Some time later, the source code could be provided to a second computer on which the compilation module 306 is implemented. Alternatively, the source code programs 302 could be developed on a computer that includes a compiler, and compiled into runnable code.

The output of the compilation module 306 is runnable code, which may be logically divided into code fragments. These code fragments may represent blocks, methods, or some other logical division. The code fragments are stored in the programs database 308. It may be noted that the code fragments may be stored as computer programs that do not share identical code fragments. The sharing of identical code fragments may come later at the client 320, for example. Or perhaps, the sharing of identical code fragments is static in the programs database 308 and dynamic sharing comes later at the client 320. For example, programs in the programs database 308 may share code fragments using a shared library.

The compilation module 306 and the programs database 308 need not be local to one another. In addition, the compilation module 306 may compile source code programs 302 into runnable code well in advance of being added to the programs database 308. For example, a computer program could be written as source code on a computer, then compiled into runnable code (e.g., a Java™ bytecode sequence). Much later, the runnable code could be added to the programs database 308.

In the example of FIG. 3, the server 310 provides code fragments from the programs database 308 to the client 320. The code fragments may be provided when a program is requested, specific code fragments are requested, or a subset of code fragments associated with a program may be provided (e.g., some code fragments may not be sent because the server knows the code fragments are already present on the client 320). The programs database 308 need not be local to the server 310 (e.g., the server 310 could be a proxy server that must request data from the programs database 308). Moreover, the server 310 need not be local to the client 320. Indeed, it is quite common for servers to be remote with respect to clients, as is well known in the art of computer networking.

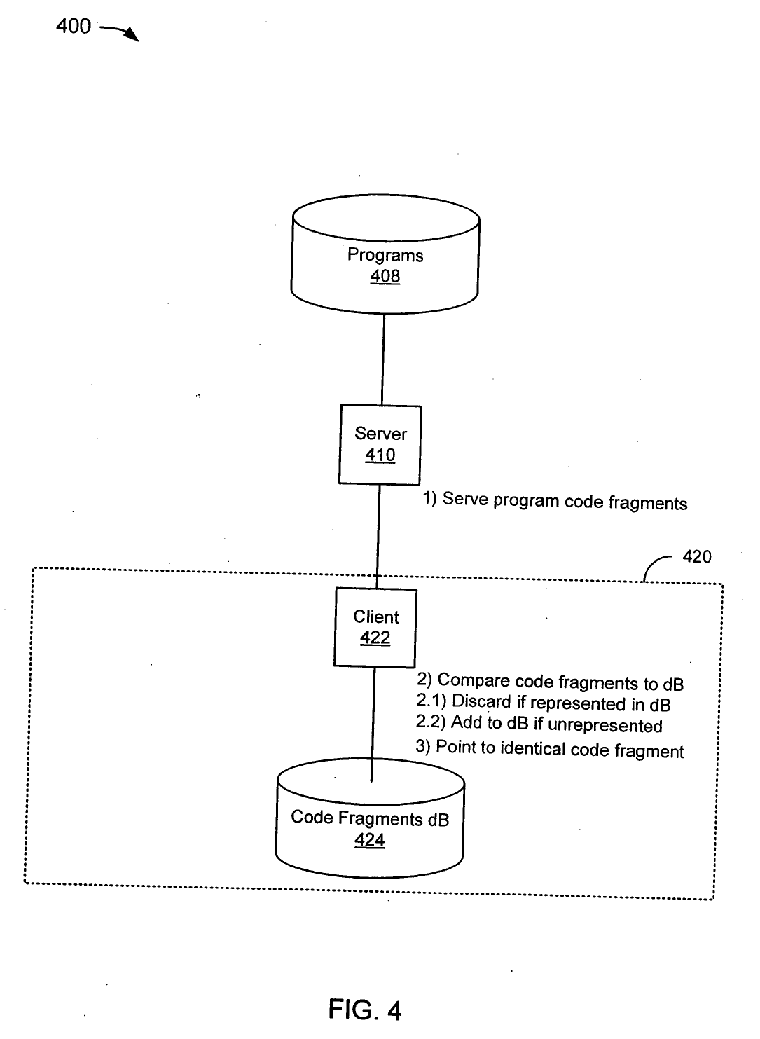

Some examples of the provisioning of code fragments to a client according to embodiments are described with reference to FIGS. 4-6. FIG. 4 depicts a system 400 for provisioning a client with programs according to an embodiment. The system 400 includes a programs database 408, a server 410, and a system 420. The system 420 includes a client 422 and a code fragment database 424. The programs database 408 and server 410 may be similar to the programs database 308 and server 310 (FIG. 3).

FIG. 4 is intended to depict an example wherein the client 422 downloads complete programs and then automatically alters the programs according to techniques described herein. This example has the advantage of facilitating the downloading of files from any compatible prior art server, regardless of whether the server is aware of the code fragments database 424 or related functionality.

In operation, the server 410 provides program code fragments from the programs database 408 to the client 422. In an embodiment, the server 410 is an HTTP server and the programs database 408 is a file structure that includes programs. In an embodiment, the system 420 is remote with respect to the server 410 and the client 422 downloads code fragments from the server 410 across a network, such as a LAN or WAN, or the Internet.

In operation, in an embodiment, when the client 422 receives the downloaded program code fragments, the client 422 compares each (or a subset of) the code fragments with a code fragments database 424. The comparison may be made by comparing, for example, a sequence of instructions with sequences of instructions that have been stored in the code fragments database 424. If a code fragment matches an entry in the code fragments database 424, then the code fragment is discarded. If a code fragment does not match an entry in the code fragments database 424, then an entry associated with the code fragment is added to the code fragments database 424.

In operation, after code fragments have been entered, if necessary, into the code fragments database 424, the data field that would have included a code fragment instead includes a pointer to the relevant code fragment in the code fragments database 424. In this way, identical code fragments can be shared by programs that point to the same code fragment entry.

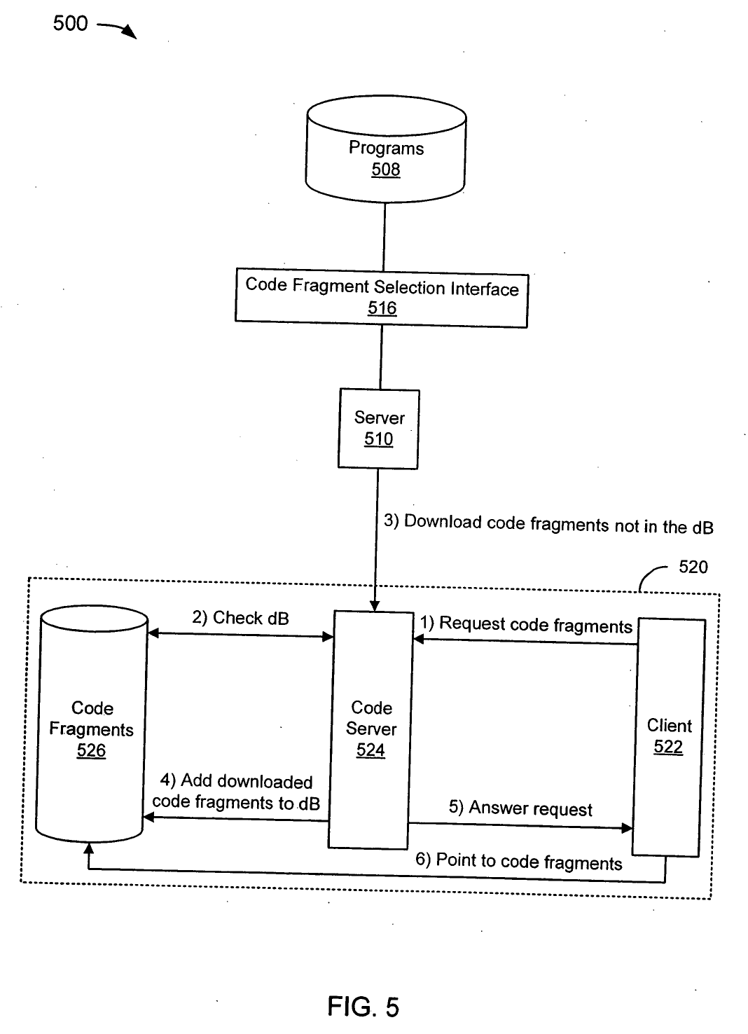

FIG. 5 depicts a system 500 for provisioning a client with programs according to another embodiment. FIG. 5 is intended to depict an example wherein bandwidth required for the download of a program is reduced. The system 500 includes a programs database 508, a server 510, a code fragment selection interface 516, and a system 520. The programs database 508 and server 510 may be similar to the programs database 308 and server 310 (FIG. 3). The code fragments selection interface 516 allows for selective download of code fragments associated with a program. The system 520 includes a client 522, a code server 524, and a code fragments database 526.

The code fragment selection interface 516 may not be available on all server systems. However, if the server 510 is implemented in an enterprise system, such as a LAN or WAN, the server may serve many systems or workstations. In this case, the enterprise may provide the code fragment selection interface 516 to reduce network bandwidth requirements when downloading from the server 510. Bandwidth requirements are reduced because a request for a program includes information related to code fragments that are already present at the requesting system. For example, if the system 520 requests a program that contains identical code fragments, the code fragment selection interface 516 may just serve one of the identical code fragments (and include a reference or other identifier in place of the code fragments that were not served). Alternatively, the code fragments selection interface may have access to a database related to what programs are on, for example, the system 520. In this alternative, the server 510 need not serve code fragments that already exist on the system 520, further reducing the bandwidth requirements associated with the download of a program.

In operation, in an embodiment, the client 522 requests from the code server 524 code fragments associated with a program. For example, the client 522 may request a program. The code server 524 checks the code fragments database 526 to determine whether any of the requested code fragments are locally available. If not, the code server 524 downloads the code fragments from the server 510. The code server 524 then adds the code fragments to the code fragments database 526 and answers the request for the code fragments from the client 522. The client 522 then references the code fragments from the code fragments database 526 using, for example, a pointer.

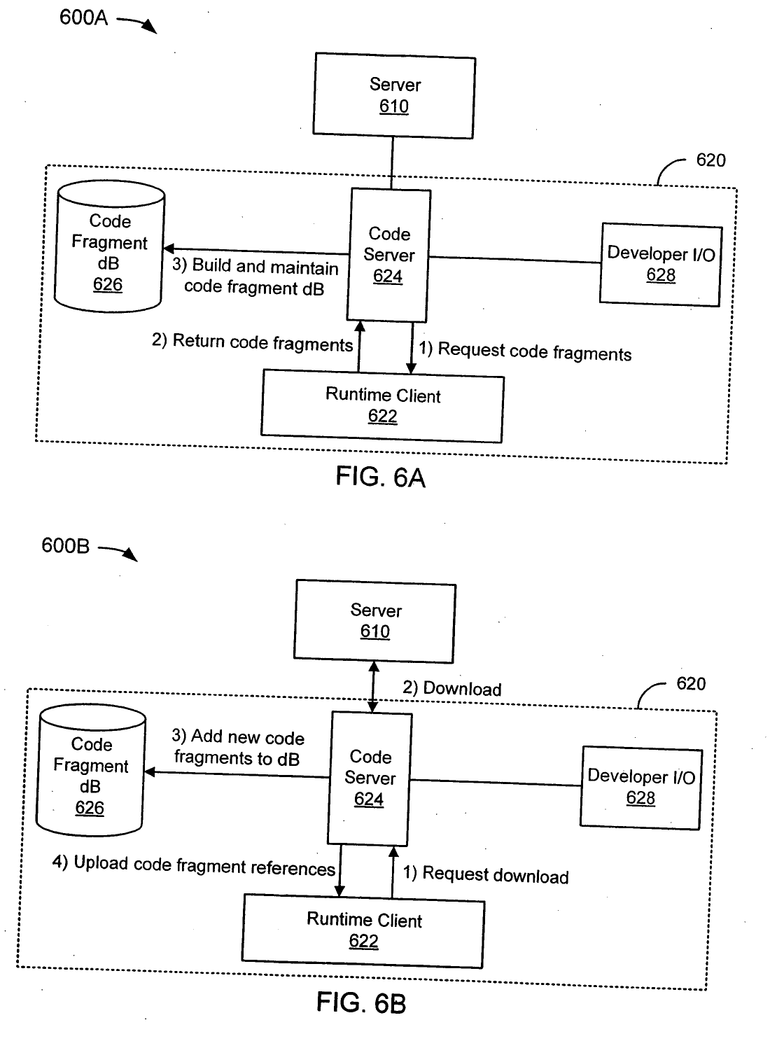

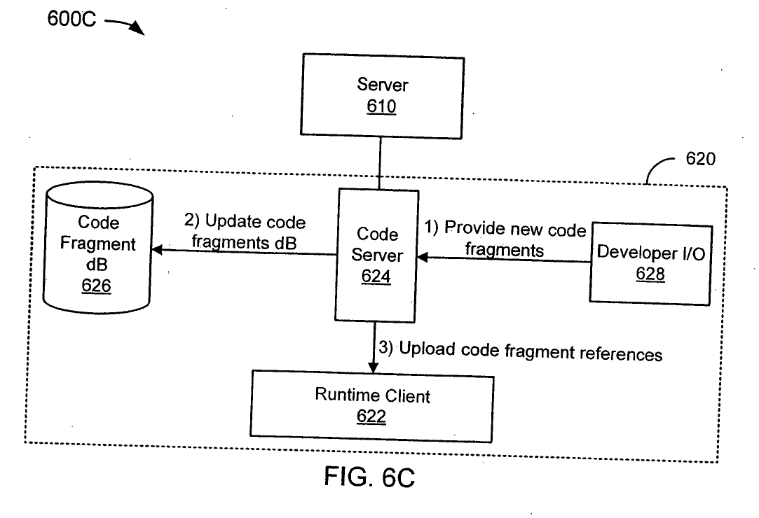

FIGS. 6A, 6B, and 6C depict systems that include a client system with a developer environment according to an embodiment. FIG. 6A depicts a system 600A in which a code server maintains a code fragment database. The system 600A includes an optional server 610 and a client system 620. The server 610 is optional because it is not used in the example of FIG. 6A and because the system 600A could be implemented without the server 610. The server 610 may be similar to the server 310 (FIG. 3). The client system 620 includes a runtime client 622, a code server 624, a code fragment database 626, and an optional developer I/O module 628. The developer I/O module 628 is optional because it is not used in the example of FIG. 6A and because the system 600A could be implemented without the developer I/O module 628.

In operation, in an embodiment, the code server 624 requests code fragments from the runtime client 622. The runtime client 622 returns the code fragments to the code server 624. In an embodiment, the code fragments may be obtained from any program on the runtime client 622. In another embodiment, the code fragments may be obtained from runtime objects or method objects. The code server uses the code fragments to build and maintain the code fragment database 626. In this way, the code fragment database 626 includes a representation of at least some of the code fragments on the runtime client 622.

FIG. 6B depicts a system 600B in which a code server maintains a code fragment database. The system 600B includes components that are similar to those of the system 600A. FIG. 6B is intended to illustrate operations that are possible in a system that includes a code fragment database 626. An example of building the code fragment database 626 was provided with reference to FIG. 6A (and it is assumed, for the purposes of example, that the code fragment database 626 includes a representation of at least some of the code fragments on the runtime client 622).

In operation, in an embodiment, the runtime client 622 requests a download of a program from the code server 624. The code server 624 may download the requested program from the server 610. It may be noted that, in an alternative embodiment, a subset of the code fragments associated with the program may be downloaded (see, e.g., FIG. 5).

In an embodiment, after downloading some or all of the program, the code server 624 adds new code fragments to the code fragment database 626. If the code fragment database 626 has identical code, then the downloaded code fragment is not new and may be discarded and replaced with a pointer to the identical code fragment in the code fragment database 626. The code server 624 may then upload to the runtime client 622 references to the code fragments. In an alternative, if a code fragment is not identical to any other code fragment, the code fragment itself may be uploaded to the runtime client 622.

FIG. 6C depicts a system 600C in which a developer can modify code fragments. The system 600C includes components that are similar to those of the system 600A. FIG. 6C is intended to illustrate a system in which a code server is integrated into a development environment, allowing a developer to dynamically upload code to and change code on a running system from within the development environment.

In an embodiment, a developer who may or may not be monitoring the system 620 may change, delete, or add code fragments “on the fly” during runtime. The developer interacts with the system 620 through the developer I/O module 628. In operation, in an embodiment, the developer I/O module 628 provides new code fragments to the code server 624. The code server 624 updates the code fragments database 626 with the new code fragments. The code server 624 then uploads references to the new code fragments to the runtime client 622. The references may replace references in the runtime client 622. Alternatively, the code fragment to which a reference points could be modified without changing the reference.

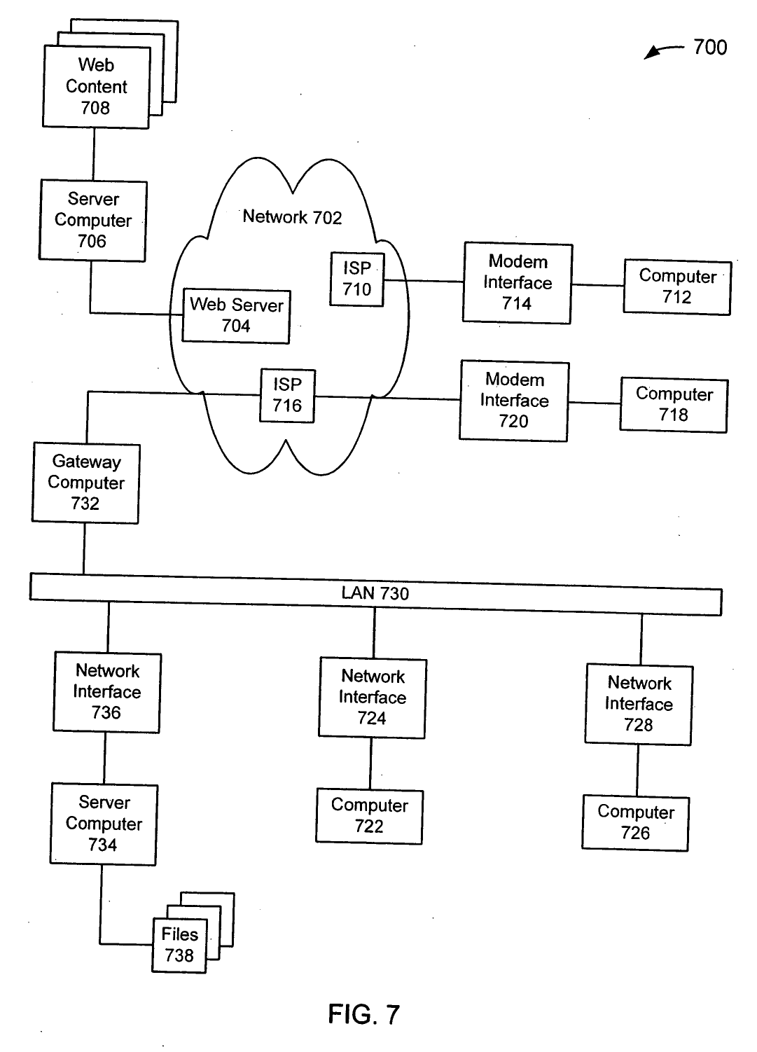

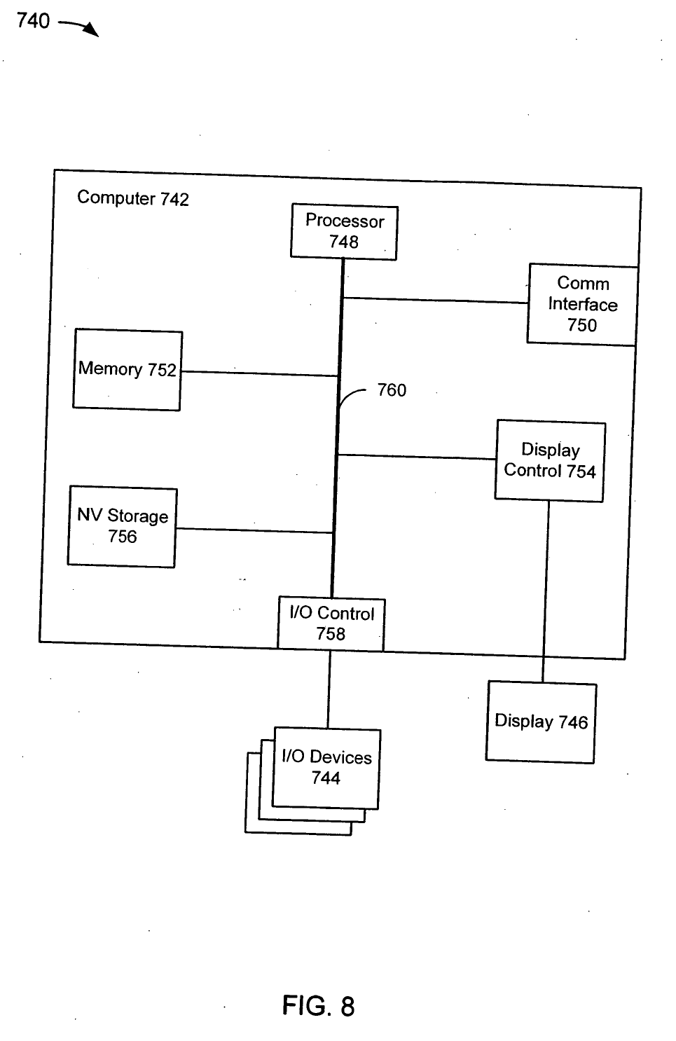

The following description of FIGS. 7 and 8 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 depicts a networked system 700 that includes several computer systems coupled together through a network 702, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 704 is typically at least one computer system which operates as a server computer system and is configured to operate with the protocols of the world wide web and is coupled to the Internet. The web server system 704 can be a conventional server computer system. Optionally, the web server 704 can be part of an ISP which provides access to the Internet for client systems. The web server 704 is shown coupled to the server computer system 706 which itself is coupled to web content 708, which can be considered a form of a media database. While two computer systems 704 and 706 are shown in FIG. 7, the web server system 704 and the server computer system 706 can be one computer system having different software components providing the web server functionality and the server 1 provided by the server computer system 706, which will be described further below.

Access to the network 702 is typically provided by Internet service providers (ISPs), such as the ISPs 710 and 716. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being “on” the Internet. Often these web servers are provided by the ISPs, such as ISP 710, although a computer system can be set up and connected to the Internet without that system also being an ISP.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. The client computer system can be a personal computer system, a network computer, a web TV system, or other computer system. While FIG. 7 shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can be ethernet network or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730 through a network interface 736 to provide files 738 and other services to the clients 722 and 726, without the need to connect to the Internet through the gateway system 732.

FIG. 8 depicts a computer system 740 for use in the system 700 (FIG. 7). The computer system 740 may be a conventional computer system that can be used as a client computer system or a server computer system or as a web server system. Such a computer system can be used to perform many of the functions of an Internet service provider, such as ISP 710 (FIG. 7).

In the example of FIG. 8, the computer system 740 includes a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. The communications interface can be an analog modem, ISDN modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor. The memory 752 is coupled to the processor 748 by a bus 760. The memory 752 can be dynamic random access memory (DRAM) and can also include static ram (SRAM). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with conventional well known technology.

The non-volatile storage 756 is often a magnetic hard disk, an optical disk, or another form of storage for large amounts of data. Some of this data is often written, by a direct memory access process, into memory 752 during execution of software in the computer 742. One of skill in the art will immediately recognize that the terms “machine-readable medium” or “computer-readable medium” includes any type of storage device that is accessible by the processor 748 and also encompasses a carrier wave that encodes a data signal.

Objects, methods, inline caches, cache states and other object-oriented components may be stored in the non-volatile storage 756, or written into memory 752 during execution of, for example, an object-oriented software program. In this way, the components illustrated in, for example, FIGS. 1-6 can be instantiated on the computer system 740.

The computer system 740 is one example of many possible computer systems which have different architectures. For example, personal computers based on an Intel microprocessor often have multiple buses, one of which can be an I/O bus for the peripherals and one that directly connects the processor 748 and the memory 752 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 752 for execution by the processor 748. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or, advantageously, it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

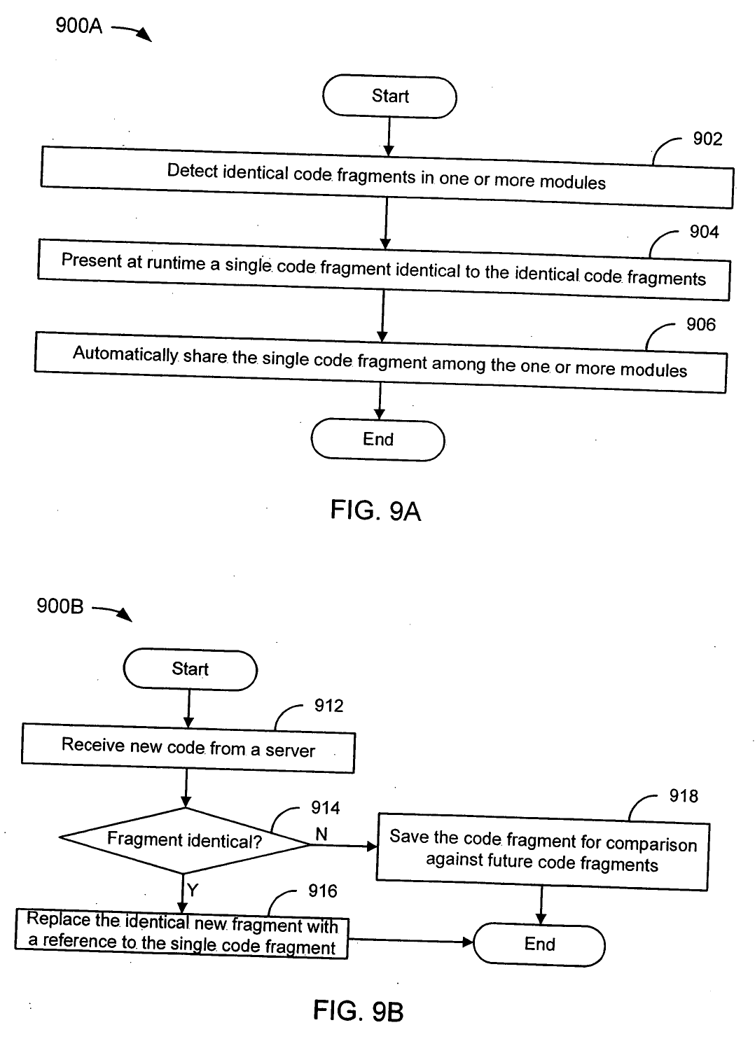

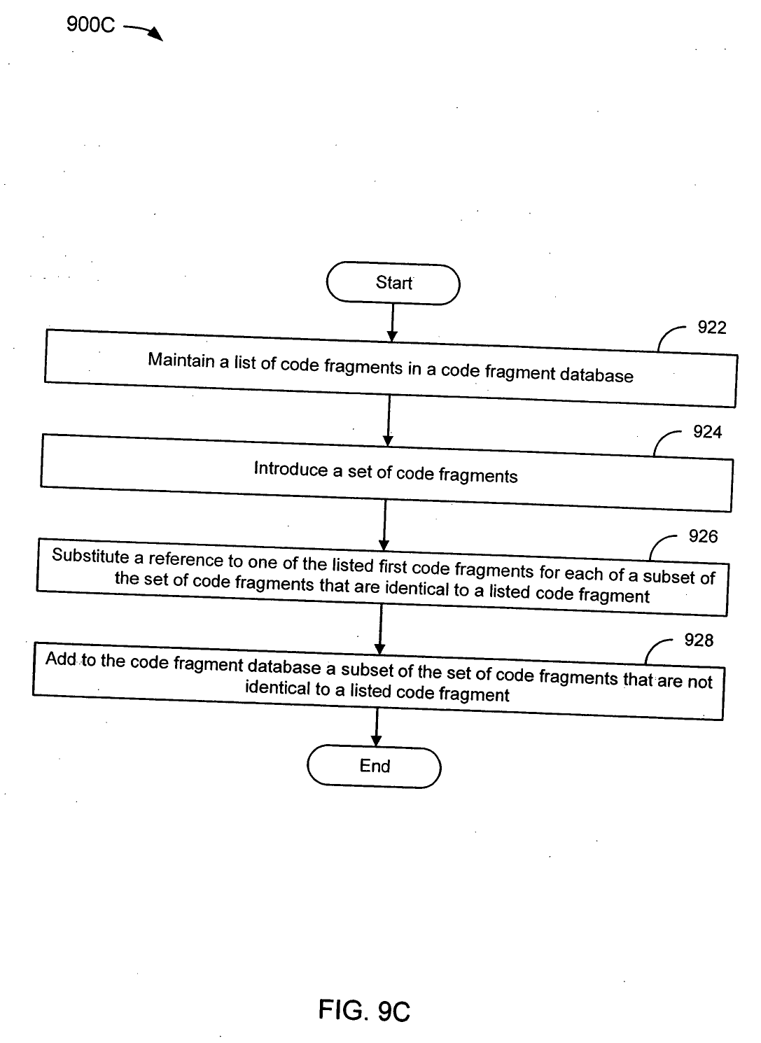

FIGS. 9A, 9B, 9C, and 9D depict flowcharts according to embodiments. FIG. 9A depicts a flowchart 900A of a process according to an embodiment. The flowchart 900A starts at block 902 where identical code fragments in one or more modules are detected. The modules, in this case, may include programs, procedures, 1, methods, objects, method objects, blocks, or some other data structure. A code fragment is identical to another code fragment if a series of associated instructions are identical. A determination as to whether code fragments are identical may be accomplished by analyzing the runnable code associated with the respective code fragments. If the code fragments include a sequence of identical instructions, then at least a part of the code fragments may be referred to as identical to one another.

In an embodiment, the flowchart 900A continues at block 904 where a single code fragment that is identical to the identical code fragments is presented at runtime. Typically, a code fragment is presented at runtime by loading the code fragment into memory, such as RAM. A code fragment that has been presented may be executed by a processor that is coupled to the memory.

In an embodiment, the flowchart 900A continues at block 906 where the single code fragment is shared among the one or more modules, then the flowchart 900A ends. In an embodiment, the sharing may involve sharing a complete method or a block. In another embodiment, the sharing may include referencing the single code fragment using pointers. For example, the objects associated with each of the identical code fragments may be pointed toward a method object. In an embodiment, the flowchart 900A may be carried out sequentially without user involvement.

FIG. 9B depicts a flowchart 900B of a process according to an embodiment. FIG. 9B is intended to depict an example of the treatment of new code fragments in a system capable of dynamically sharing code fragments. The flowchart 900B starts at block 912 where new code is received from a server.

In an embodiment, the flowchart 900B continues at decision point 914 where it is determined whether a sharable code fragment is identical to a code fragment in the new code. If it is determined that the sharable code fragment is identical to the code fragment in the new code (914-Y), then the flowchart 900B continues at block 916 where the code fragment in the new code is replaced with a reference to the sharable code fragment, then the flowchart 900B ends. If it is determined that the sharable code fragment is not identical to the code fragment in the new code (914-N), then the flowchart 900B continues at block 918 where the code fragment in the new code is saved for comparison against code fragments from future new codes, then the flowchart 900B ends.

FIG. 9C depicts a flowchart 900C of a process according to an embodiment. FIG. 9C is intended to depict an example of introducing new code to a system that includes a code fragment database. The flowchart 900C starts at block 922 where a code fragment database is maintained with a list of first code fragments. The listed code fragments may be maintained by, for example, a code server.

In an embodiment, the flowchart 900C continues at block 924 where a set of code fragments is introduced. The set of code fragments may be introduced by, for example, downloading a program or dynamically uploading code at runtime.

In an embodiment, the flowchart 900C continues at block 926 where, for a subset of the set of code fragments that are identical to a listed code fragment, a reference to one of the list of first code fragments is substituted for the code fragment itself. In this way, the listed code references can be shared by, for example, new code that includes identical code references.

In an embodiment, the flowchart 900C continues at block 928 where, for a subset of the set of code fragments that are not identical to any of the listed code fragments, the code reference is added to the code fragment database. In this way, the code fragment database remains up-to-date based on the latest code fragments. After block 928, the flowchart 900C ends.

As used herein, identical runnable code fragments may be derived from semantically equivalent source code fragments (and it is not particularly relevant whether semantically-equivalent source code fragments are also syntactically identical because it is the functionality of the runnable code fragment that is of consequence). It may be noted that it is possible for non-equivalent source code to have source code fragments that, when translated into runnable code, are identical.

While this invention has been described by way of example in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

What is claimed is:

1. A process, comprising:
detecting identical code fragments in one or more modules;
presenting at runtime a single code fragment that is identical to the identical code fragments; and
automatically sharing the single code fragment among the one or more modules.

2. The process of claim 1, wherein the modules include objects.

3. The process of claim 1, wherein said detecting identical code fragments includes analyzing runnable code.

4. The process of claim 1, wherein said automatically sharing the single code fragment includes sharing a complete method.

5. The process of claim 1, wherein said automatically sharing the single code fragment includes sharing a block.

6. The process of claim 1, wherein said automatically sharing the single code fragment involves referencing the single code fragment using pointers.

7. The process of claim 1, wherein said single code fragment includes a method object, and wherein said automatically sharing the single code fragment includes pointing objects associated with each of the identical code fragments to the method object.

8. The process of claim 1, wherein said detecting identical code fragments, presenting the single code fragment at runtime, and automatically sharing the single code fragment occur sequentially without user involvement.

9. The process of claim 1, further comprising:
receiving new code from a server;
determining whether the single code fragment is identical to a code fragment in the new code;
replacing the code fragment in the new code with a reference to the single code fragment if it is determined that the single code fragment is identical to the code fragment in the new code; and
saving the code fragment in the new code for comparison against code fragments from future new codes if it is determined that the single code fragment is not identical to the code fragment in the new code.

10. The process of claim 1, further comprising:
maintaining a list of first code fragments, including the single code fragment, in a code fragment database;
introducing a set of second code fragments, each of which are identical to a code fragment in the code fragment database, and a set of third code fragments, none of which are identical to a code fragment in the code fragment database, by:
substituting a reference to one of the first code fragments for each of the set of second code fragments;
adding each of the set of third code fragments to the code fragment database.

11. The process of claim 1, further comprising dynamically uploading code at runtime.

12. The process of claim 1, further comprising:
writing source code of a program in a programming language;
translating the source code into runnable code; and
providing the runnable code as at least one module of the one or more modules.

13. The process of claim 12, wherein said executing the runnable code includes executing the runnable code using a virtual machine.

14. A system, comprising:
a code fragments database that includes a plurality of code fragments; and
a code server configured to receive requests for a program and provide references to one or more of the plurality of code fragments in the code fragments database, wherein the one or more of the plurality of code fragments are associated with the requested program.

15. The system of claim 14, wherein the code server is further configured to detect identical code fragments in one or more objects.

16. The system of claim 14, wherein the code server is further configured to download the program and update the code fragments database in accordance with code fragments in the program.

17. The system of claim 14, wherein the code server is further configured to build and maintain the code fragments database.

18. The system of claim 14, further comprising a developer I/O module configured to provide new code fragments to the code server, wherein the code server is further configured to update the code fragment database according to the new code fragments.

19. A system, comprising:
a first object, including a reference associated with -a first named method;
a second object, including a reference associated with a second named method; and
a method object, wherein the reference associated with the first named method and the reference associated with the second named method are pointers to the method object.

20. The system of claim 19, wherein the first object and the second object are associated with different classes.
